(19) United States
(12) Patent Application Publication
(10) Pub. No.: US 2007/0160405 A1
(43) Pub. Date: Jul. 12, 2007

(54) PRINTER

(75) Inventors: Kazutaka Suzuki, Fukushima-ken (JP); Hiroyuki Murayama, Fukushima-ken (JP)

Correspondence Address: BRINKS HOFER GILSON & LIONE, P.O. BOX 10395, CHICAGO, IL, 60610, US

(73) Assignee: ALPS ELECTRONICS CO., LTD., Tokyo (JP)

(21) Appl. No.: 11/617,674

(22) Filed: Dec. 28, 2006

(30) Foreign Application Priority Data
Jan. 6, 2006 (JP) 2006-001469

(51) Int. Cl. B41J 2/315

(52) U.S. Cl. 400/120.16

(57) ABSTRACT

There is provided a printer which can suppress the variations in rotation speed of a platen and the forwarding speed of a recording medium when a recording unit abuts on a platen through the recording medium. The printer of the present invention includes a platen, a recording unit, and a brake. The brake presses a friction member to a smooth side surface of a rotation gear fixed a rotation shaft of the platen from the time point before the recording unit abuts on the platen through the recording medium. Accordingly, the platen rotates while constantly receiving a braking force by the braking device. Therefore, even though the recording unit abuts on the platen and the rotation speed of the platen is varied, the pulsation of the platen is suppressed.

This patent document claims the benefit of Japanese Patent Application 2006-001469 filed on Jan. 6, 2006, which is hereby incorporated by reference.

### BACKGROUND OF THE INVENTION

1. Field

The present embodiments relate to a printer.

2. Related Art

Generally, a thermal printer thermally transfers ink to a recording medium using a variety of ink ribbons and thermal heads. The thermal printer is widely used as a form of a color printer, which records a variety of ink on the recording medium.

As shown in FIG. 3, a known thermal printer 101 includes a roller-shaped platen 103 and four thermal transfer type recording units 104 disposed in a circumferential direction of the platen 103. Each recording unit 104 has a thermal head 104a facing the platen 103 and an ink ribbon 104b of a color mounted on the corresponding recording unit 104 to be interposed between the platen 103 and the thermal head 104.

The recording unit 104 can freely move in contacting and separating directions ZD about the platen 103. In the known thermal printer 101, a recording medium 110 forwarded in a predetermined forwarding direction FD is interposed between the platen 103 and the ink ribbon 104b. The recording units 104 move in a direction (hereinafter, referred to as ‘approaching direction’) sequentially adjacent to the platen 103 from the recording unit on an upstream side. The ink ribbon 104b abuts on the recording medium 110. Ink of the ink ribbon 104b is thermally transferred to the recording medium 110 by heating the thermal head 104a.

In the known thermal printer 101, displacement of a location or a blank portion, for example, jitter (recording stain), can be prevented by correcting the energization starting timing of the thermal head 104a disposed on a downstream side on the basis of the driving capability of a stepping motor (not shown) rotating the platen 103 and the energization starting timing of the thermal head 104a disposed on an upstream side (see Patent Document 1).

[Patent Document 1] Japanese Unexamined Patent Application Publication No. 2003-251840

However, as shown in FIG. 4, when the recording unit 104 abuts on the recording medium 110, and the recording medium 110 and the platen 103 are impacted at T1, the forwarding speed V0 of the recording medium 110 and the rotation speed of the platen 103 decreases. Since the stepping motor driving the platen 103 changes a driving force thereof to recover the decreased rotation speed to a predetermined rotation speed, there is a problem that the forwarding speed V0 of the recording medium 110 is varied within a range of V0±α. A recording unit 104 disposed on the upstream side of the recording unit 104 abutting on the recording medium 110 generates the jitter, thereby deteriorating printed images or characters.

### SUMMARY

The present embodiments may obviate one or more of the limitations or drawbacks of the related art. For example, in one embodiment, a printer can suppress the variation in rotation speed of a platen and the forwarding speed of a recording medium when a recording unit abuts on the platen via the recording medium.

In one embodiment, a printer includes a platen that rotates while supporting a forwarded recording medium. A plurality of recording units freely move in contacting and separating directions about the platen and performing a printing operation in contact with the recording medium. A controller applies a braking force to the rotation of the platen from the time point before the recording unit abuts on the platen.

In one embodiment, the controller includes a plate-shaped member which has at least one smooth side surface, which is fixed to a rotation shaft of the platen so as to make the rotation shaft of the platen parallel to a normal of the side surface. A friction member abuts on the smooth side surface of the plate-shaped member. A biasor biases the friction member to the smooth side surface.

In one embodiment, the plate-shaped member is a gear connected to a driver and rotates the platen.

In one embodiment, the plate-shaped member is formed of an iron alloy and the friction member is formed of a copper sintered alloy.

In one embodiment, the controller includes a positioning unit that moves the friction member in the contacting and separating directions about the plate-shaped member and adjusts a position of the friction member.

In one embodiment, the controller includes a braking force adjusting unit, which decreases the braking force applied to the platen, depending on an increase of the number of the recording units contacting the platen.

In one embodiment, even though the recording unit abuts on the platen and the rotation speed of the platen is varied, the brake brakes the pulsation from the time point before the recording unit is in contact with the platen. Therefore, it is possible to suppress the variation in rotation speed of the platen and the forwarding speed of the recording medium, thereby preventing occurrence of jitter.

In one embodiment, the mounted plate-shaped member rotates while constantly receiving a frictional force form a friction member. Therefore, even though the recording unit abuts on the platen and the rotation speed of the platen is varied, the braking force is constantly applied to a direction opposite to a pulsation direction of the rotation speed of the platen.

In one embodiment, since it may not be necessary to form the plate-shaped member and a gear separately, it is possible to prevent the increase in number of parts and save a space.

In one embodiment, since a friction coefficient between the plate-shaped member and the friction member increases, the brake applies the high braking force with respect to the variation in rotation speed of the platen.

In one embodiment, even though the plate-shaped member and the friction material are worn, the frictional forces thereof can be constantly maintained. Therefore, a desired braking force may be applied to the platen.

In one embodiment, since an increased contacting force of the recording unit is used as the braking force and the frictional force applied to the plate-shaped member from the friction member of the brake may be reduced, the braking force applied to the plate-shaped member from the friction member of the brake is constantly maintained and a load given to the driver, which rotates the platen, may be reduced.

### BRIEF DESCRIPTION OF THE DRAWINGS

FIG. 1 is a side view showing one embodiment of a printer.

FIG. 2 is a plan view conceptually showing one embodiment of an end portion of a rotation shaft rotating a platen.

FIG. 3 is a side view showing a known thermal printer.

FIG. 4 is a graph showing a variation of the forwarding speed with time of a recording medium forwarded in a known thermal printer.

### DETAILED DESCRIPTION

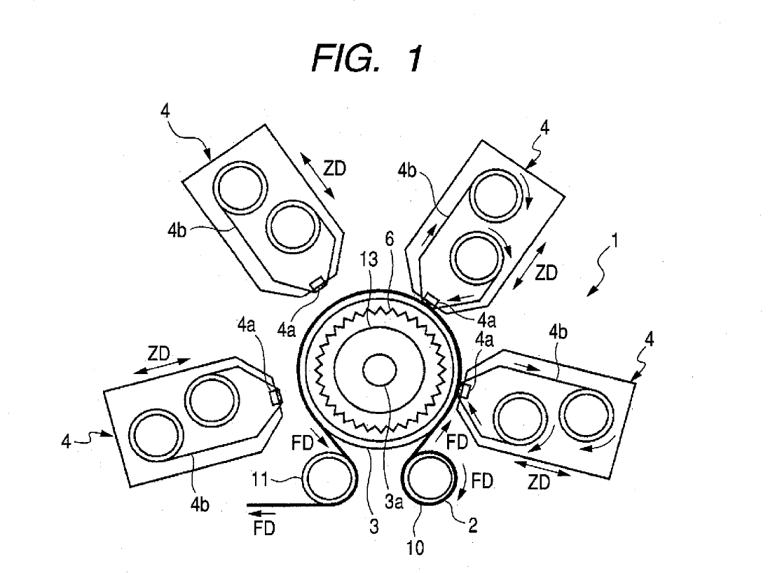

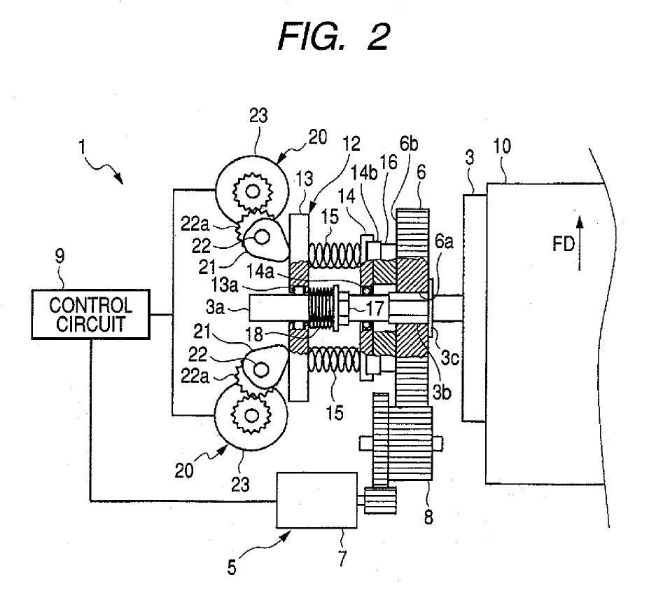

In one embodiment, as shown in FIG. 1, a printer 1 includes a feed roller 2, a platen 3, a discharge roller 11, four recording units 4, and a control circuit (shown only in FIG. 2) in a case (not shown) of the printer 1.

In one embodiment, the feed roller 2 and the discharge roller 11 have roll widths larger than the width of a roll paper 10. The feed roller 2 and the discharge roller 11 rotate to feed or discharge the roller paper 10 in a predetermined forwarding direction FD by using respective stepping motors (not shown). The roll paper 10 is rolled onto the feed roller 2. A cutter (not shown) that cuts the roll paper 10 is disposed on the downstream side of the discharge roller 11 in a forwarding direction FD.

In one embodiment, the platen 3 is formed in a roller shape. The platen 3 has a diameter suitable for disposing four recording units 4 by facing each other and the roll width larger than the width of the roll paper 10. The platen 3 is disposed between the feed roller 2 and the discharge roller 11 in a forwarding path of the roll paper 10. The roll paper 10 includes a substantially horseshoe (Ω) shape and is disposed in close contact with the surface of the platen 3. The platen 3 rotates to forward the roll paper 10 in the predetermined forwarding direction FD by using a separate stepping motor (not shown).

FIG. 2 is a view conceptually showing a periphery of one end portion of a rotation shaft 3a rotating the platen 3. FIG. 2 is a fragmentary cross-section view of a rotation gear 6, a friction member 16, an attaching plate 14, and a supporting plate 13 mounted in the periphery of the rotation shaft 3a. In one embodiment, as shown in FIG. 2, a driver 5 rotates the platen 3 and a brake 12 applies a braking force to the rotation of the platen 3 formed in the periphery of one end portion of the rotation shaft 3a of the platen 3.

In one embodiment, the driver 5 rotates the platen 3 by transferring the driving force of a driving motor 7 as the driving force to a rotation gear 6 fixed to the rotation shaft 3a of the platen 3 through a transmission gear 8. The rotation gear 6 is formed in the shape of a spur gear having an attaching hole 6a penetrating in a shaft direction and having a shaft-direction cross-sectional hexagon and a smooth side surface 6b.

In one embodiment, the rotation gear 6 is used as the plate-shaped member. In the rotation gear 6, the attaching hole 6a is fixed by fitting to the attaching portion 3b of the shaft-direction cross-sectional hexagon partially formed on one end portion of the rotation shaft 3a of the platen 3. It is preferable that the material of the rotation gear 6 includes iron alloys used as the material of an automotive metal brake rotor such as a cast iron alloy or a stainless alloy. The attaching portion 3b of the rotation shaft 3a has a flange portion 3c, which prevents the rotation gear 6 from sliding to the inner side of the shaft direction of the platen 3

In one embodiment, the brake 12 includes the supporting plate 13, the attaching plate 14, an elastic member, a friction member 16, and a cam unit 20. The supporting plate 13 is a donut-shaped disk having an inside diameter larger than the diameter of the rotation shaft 3a. The supporting plate 13 is rotatably mounted on an outer end portion of the rotation gear 6 on the rotation shaft 3a through a needle bearing 13a. The supporting plate 13 is biased outwardly in the shaft direction of the platen 3 by a coil spring 18 of which one end portion is fixed with a washer nut mounted on the rotation shaft 3a of the platen 2. The attaching plate 14 is the donut-shaped disk having an inside diameter larger than the diameter of the rotation shaft 3a. The attaching plate 14 is rotatably mounted between one abutting on the rotation gear 6 among the supporting plate 13 and the washer nut 17, and the rotation gear 6 through a ball bearing 14a. The elastic member 15 connects the supporting plate 13 and the attaching plate 14, and biases inwardly in the shaft direction of the platen 3. The elastic member 15 is used as a biasor. In this embodiment, a coil spring is used as the elastic member 15.

In one embodiment, the friction member 16 of the brake 12 is the donut-shaped disk having an inside diameter larger than the diameter of the rotation shaft 3a. The friction material of the brake 12 is mounted to the attaching plate 14 through a fixing member 14b. The friction member 16b includes the material of an automotive metal brake pad, for example, a copper sintered alloy which a hard phase consisting of one or two or more compounds of iron metal compounds, for example, FeMo, FeCr, FeTi, FeW, or FeB is uniformly dispersed to a Sn—Cu copper alloy base.

In one embodiment, the cam unit 20 of the brake 12 includes a plate cam 21 which has a substantially eggshell-shaped end face abutting on the supporting plate 13, a cam shaft 22 on which the plate cam 21 is mounted, and a cam shaft motor 23 which intermittently rotates the cam shaft 22 through a cam shaft gear 22a. The cam unit 20 is used as a positioning unit and a braking force adjusting unit. In addition, the plurality of cam units 20 are disposed and interlocked with each other.

In one embodiment, as shown in FIG. 1, the recording unit 4 is used in thermal transfer type recording units 4. The recording units 4 may include ink ribbons 4b having one of inks having, for example, four colors of yellow, magenta, cyan, and black, and thermal heads 4a. The four recording units 4 are disposed in parallel in the circumferential direction of the platen so that each thermal head 4a faces the platen 3. The four recording units 4 intermittently move in contacting and separating directions ZD about the platen 3.

In one embodiment, a control circuit 9 is a circuit having an arithmetic processing unit such as CPU and a storage unit, for example, a memory. The control circuit 9 is connected to respective stepping motors of the feed roller 2, the discharge roller 11 and the platen 3 shown in FIG. 1 or the recording unit 4 (not shown), and the control circuit 9 controls the rotation speed of each stepping motor. In one embodiment, as shown in FIG. 2, the control circuit 9 is connected to the driving motor 7 of the driving device 5 and the cam shaft motor 23 of the braking device 12, and controls the rotation speed of each motor 7, 23.

In one embodiment, as shown in FIG. 1, the roller paper 10 is forwarded in a predetermined forwarding direction FD by the rotations of the feed roller 2, the platen 3 and the discharge roller 11. The roll paper 10 is in close contact with a surface of the platen 3 by controlling the rotation speed of the feed roller 2 and the discharge roller 11, the roll paper 10, the four recording units 4 abut on the roll paper 10 one by one from the recording unit 4 disposed on the most upstream side in the forwarding direction FD. The recording units 4 abutting on the roll paper 10 heats the thermal head 4a and melts the ink ribbon 4b. Therefore the recording unit 4 performs the thermal transfer operation (printing operation).

In one embodiment, as shown in FIG. 2, the rotation gear 6, which is the plate-shaped member, is mounted to the rotation shaft 3a of the platen 3 and the friction member 16 is pressure-welded to the side surface 6b of the rotation gear 6. A frictional force in a direction opposite to the rotation direction of the platen 3 is constantly applied to the rotation gear 6 from the time point before the recording unit 4 abuts on the platen 3. Even though the recording unit abuts on the platen and the rotation speed of the platen 3 is varied, the variation in rotation speed has the amplitude smaller than that of a known printer 101 to which the braking force (frictional force) is not applied. Accordingly, it is possible to suppress the variation in forwarding speed of the roll paper 10.

In one embodiment, the rotation gear 6 mounted to the rotation shaft 3a of the platen 3 is used as the plate-shaped member which pressure-welds the friction member 16. Accordingly, it may not be necessary to form the plate-shaped member and the rotation gear 6 separately, it may be possible to prevent the increase in number of parts and save the space.

In one embodiment, since the rotation gear 6 is formed of an iron alloy and the friction member 16 as an opposite friction member is formed of a copper sintered alloy, the rotation gear 6 and the friction member formed as described above show higher friction coefficient and more excellent heat radiation performance than the rotation gear 6 and the friction member 16 formed inorganic material or rubber material. As the result, a high braking force may be stably applied to the platen 3.

In one embodiment, the friction member 16 and the rotation gear 6 suppress the vibrations of the platen 3 and the roll paper 10 by sliding. In this embodiment, the friction member 16 and the rotation gear 6 are worn and are reduced in thickness. When the friction member 16 and the rotation gear 6 are reduced in thickness, the position of the friction member 16 moves inwardly in the shaft direction of the platen 3 by the elastic force of the elastic member 15. Therefore, since the elastic member 15 biasing the friction member 16 to the rotation gear 6 increases in length, the elastic member 15 is reduced in elastic force in accordance with Hook's law.

In one embodiment, the cam unit 20 acting as the positioning unit, which adjusts the position of the friction member 16, intermittently rotates the plate cam 21 and push out the supporting plate 13 inwardly in the shaft direction of the platen 3 to adjust the length of the elastic member 15 to a predetermined length.

In one embodiment, the rotation gear 6 and the friction member 16 are worn. In this embodiment, it may be possible to constantly maintain the frictional forces of the rotation gear 6 and the friction member 16 by adjusting them. Therefore, a desired braking force can be applied to the platen 3.

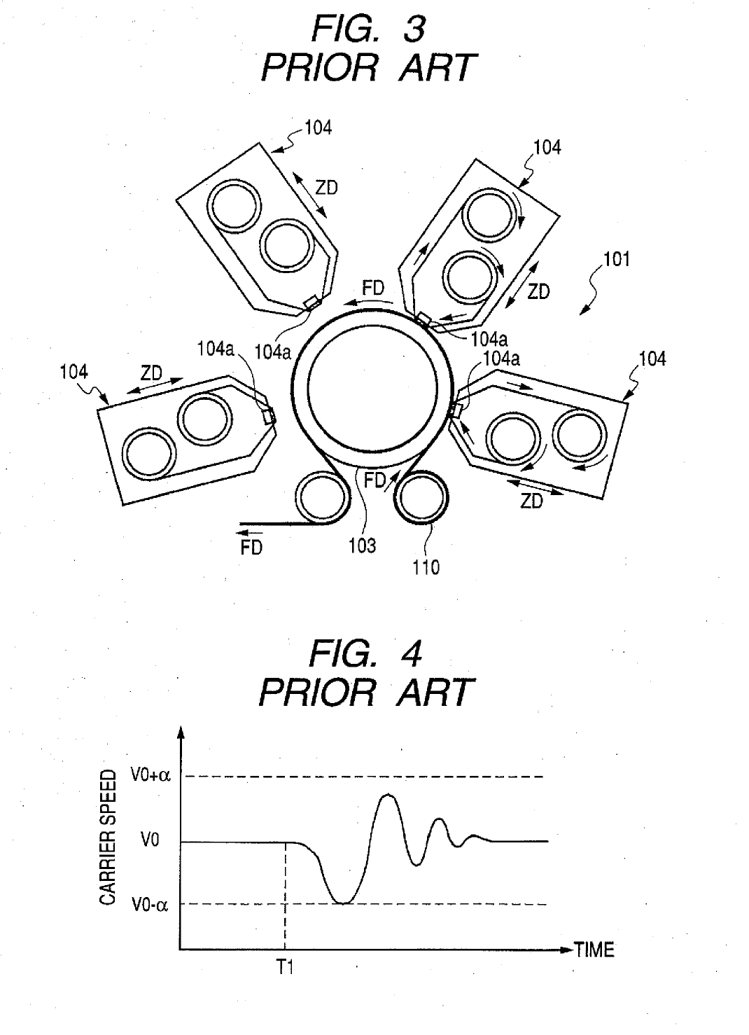

In one embodiment, the variation in rotation speed of the platen 3 and a forwarding speed of the roll paper 10 are suppressed in spite of the abutment of each recording unit 4 because the braking force is applied to the platen 3 by the braking device 12. Alternatively, as shown in FIG. 2, the load applied to the driving motor 7 of the platen according to the present embodiment is higher than the load applied to the driving motor (not shown) driving the known plate 103 (see FIG. 3) by the braking force.

In one embodiment, the number of the abutments of the recording units of the platen 3 is increased. The braking force applied from the brake is reduced. As a method of reducing the braking force, when the recording units 4 abut one by one from the upstream side, the cam unit 20 acting as the braking force adjusting unit intermittently rotates the plate cam 21 by the control of the control circuit 9 to discharge the extrusion pressure by which the supporting plate 13 is pushed out inwardly in the shaft direction of the platen 3 and the coil spring 18 biasing the supporting plate 13 pushes out the supporting plate 13 outwardly in the shaft direction of the platen 3 to reduce the frictional force applied to the rotation gear 6.

For example, it is assumed that the maximum frictional force is applied to the platen 3 by the braking device 12 and the abutment force which are applied to the platen 3 by the four recording units 4 is ‘1’. Before the recording unit 4 abuts on the platen 3, the braking device 12 adds the maximum frictional force ‘1’ to the platen 3, and whenever the number of the abutting recording units 4 increases to ‘1, 2, 3, and 4’, the frictional force which is applied to the platen 3 by the braking device 12 decreases to ‘1 (one abutment), 2 (two abutments), 0.5 (three abutments), and 0 (four abutments)’.

In one embodiment, since the abutment force of the recording unit 4 is used as the braking force and the frictional force applied to the rotation gear 6 may be reduced, the load applied to the driving motor 7 is the same as the load applied to the driving motor of the known platen 103 (see FIG. 3) by reducing the load to the driving motor 7 by the maximum frictional force while maintaining the braking force applied to the platen 3 over a predetermined value.

For example, since it is possible to suppress the variation in rotation speed of the platen 3 and the transfer speed of the roll paper 10 without applying a load higher than the load applied to the driving motor of the known platen to the driving motor 7 of the platen 3, it is possible to prevent the jitter from being generated.

The present invention is not limited to the embodiments described above, but may be variously changed as necessary.

For example, a braking device which presses the friction member 16 on the side surface 6b of the rotation gear 6 by using a hydraulic cylinder controlled by the control circuit may be used instead of the braking device 12 according to the present embodiment of the invention. In another embodiment, a drum brake type braking device, which presses a brake shoe on the inner side of the drum mounted on the rotation shaft 3a of the platen may be used.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

What is claimed is:

1. A printer comprising:
a platen that is operative to rotate while supporting a forwarded recording medium;
a plurality of recording units that are operative to freely move in contacting or separating directions about the platen and perform a printing operation in contact with the recording medium; and
a controller that is operative to apply a braking force to the rotation of the platen from the time point before the recording unit abuts on the platen.

2. The printer according to claim 1, wherein the controller includes a plate-shaped member which has at least one smooth side surface.

3. The printer according to claim 2, wherein the at least one smooth side surface is fixed to a rotation shaft of the platen so as to make the rotation shaft of the platen parallel to a normal of the side surface.

4. The printer according to claim 3, wherein a friction member abuts on the smooth side surface of the plate-shaped member, and a biasor is operative to bias the friction member to the smooth side surface.

5. The printer according to claim 2, wherein the plate-shaped member includes a gear connected to a driver that is operative to rotate the platen.

4. The printer according to claim 2, wherein the plate-shaped member is formed of an iron alloy, and wherein the friction member is formed of a copper sintered alloy.

5. The printer according to claim 2, wherein the controller includes a positioning unit that moves the friction member in the contacting and separating directions about the plate-shaped member and adjusts a position of the friction member.

6. The printer according to claim 1, wherein the controller includes a braking force adjusting unit which decreases the braking force applied to the platen, depending on an increase of the number of the recording units contacting the platen.

7. A method for printing, comprising:
rotating a platen, which forwards a roller paper;
abutting a recording unit on the roller paper;
heating the recording head; and
applying a frictional force in a direction opposite to the rotation direction of the platen to the from the time point before the recording unit abuts on the platen.

8. The method for printing according to claim 7, wherein a rotation shaft of the platen and a friction member are pressure-welded to a side surface of a rotation gear 6.

9. The method for printing according to claim 7, the frictional force is in a direction opposite to the rotation direction of the platen and is constantly applied to the rotation gear from the time point before the recording unit abuts on the platen.

10. The method for printing according to claim 7, wherein even though the recording unit abuts on the platen and the rotation speed of the platen is varied, the pulsation of the platen is suppressed.
